(19) United States
(12) Patent Application Publication
(10) Pub. No.: US 2014/0144988 A1
(43) Pub. Date: May 29, 2014

(54) POINT-OF-SERVICE DEVICE AND READING SENSOR THEREOF

(71) Applicant: FLYTECH TECHNOLOGY CO., LTD, Taipei City (TW)

(72) Inventor: CHIH KUANG CHIANG, Taipei City (TW)

(73) Assignee: FLYTECH TECHNOLOGY CO., LTD, Taipei City (TW)

(21) Appl. No.: 13/789,815

(22) Filed: Mar. 8, 2013

(30) Foreign Application Priority Data
Nov. 26, 2012 (TW) 101222874

(51) Int. Cl. G06K 7/01

(52) U.S. Cl. CPC G06K 7/01
USPC 235/449; 235/439

(57) ABSTRACT

A point-of-service device includes a point-of-service display, a first reading sensor, and a second reading sensor. The point-of-service display includes a modular slot. The first reading sensor includes a first modular plug matching the modular slot. The second reading sensor includes a second modular plug matching the modular slot. Moreover, either the first modular plug or the second modular plug is allowed to be inserted into the modular slot at the same time.

### FIELD OF THE INVENTION

The present invention relates to a point-of-service device, and more particularly to a point-of-service device with an easily replaceable reading sensor.

### BACKGROUND OF THE INVENTION

With the advancement of science and technology, the concepts of electronic wallets and smart cards are gradually and widely adopted. Consequently, the demands on the number of point-of-service (POS) devices are increased. For example, point-of-service devices are usually installed in many business places for quickly and conveniently confirming the information between the users and the computers.

Generally, a conventional point-of-service device comprises a display screen and a reader. Before the conventional point-of-service device leaves the factory, the reader is integrally fixed on the display screen. In other words, when the conventional point-of-service device leaves the factory, the function of the conventional point-of-service device is determined and fails to be expanded.

Nowadays, in some conventional point-of-service devices, the display screen and the reader are detachable. The display screen has an insertion slot. The reader has a plug matching the insertion slot. After the plug of the reader is inserted into the insertion slot of the display screen, the reader may be securely fixed on the display screen by screwing means. As known, it is time-consuming to assembly the conventional point-of-service device by tightening the screws. Moreover, since an additional screwdriver or assembling/disassembling tool is needed, the process of assembling the conventional point-of-service device is not user-friendly.

Moreover, the readers for providing different functions usually have different types of plugs. For complying with different types of plugs, the display screen should be equipped with a plurality of insertion holes. Under this circumstance, the outer appearance of the display screen is not aesthetically pleasing, and the fabricating cost is increased.

Therefore, there is a need of providing a point-of-service device with an easily and quickly replaceable reading sensor so as to obviate the drawbacks encountered from the prior art.

### SUMMARY OF THE INVENTION

The present invention provides a point-of-service device with a modular slot and a modular plug. Consequently, various reading sensors for providing different functions can be applied to the point-of-service device in order to expand the functions of the point-of-service device. In addition, the process of assembling or disassembling the reading sensor is convenient and quick.

In accordance with an aspect of the present invention, there is provided a point-of-service device. The point-of-service device includes a point-of-service display, a first reading sensor, and a second reading sensor. The point-of-service display includes a modular slot. The first reading sensor may be inserted into the modular slot of the point-of-service display. The first reading sensor includes a first main body and a first modular plug. The first main body includes a first reading unit. The first modular plug is fixed on the first main body and electrically connected with the first reading unit. The first modular plug matches the modular slot. The second reading sensor may be inserted into the modular slot of the point-of-service display. The second reading sensor includes a second main body and a second modular plug. The second main body includes a second reading unit. The second modular plug is fixed on the second main body and electrically connected with the second reading unit. The second modular plug matches the modular slot. Moreover, either the first modular plug or the second modular plug is allowed to be inserted into the modular slot at the same time.

In an embodiment, the first modular plug includes a first conducting part, and the second modular plug includes a second conducting part. The first conducting part and the second conducting part have the same outer appearance. The modular slot includes a single connecting port corresponding to the first conducting part or the second conducting part. Moreover, either the first conducting part or the second conducting part is allowed to be inserted into the single connecting port.

In an embodiment, the first modular plug includes a first conducting part, and the second modular plug includes a second conducting part. The first conducting part and the second conducting part have different outer appearances. The modular slot includes two different connecting ports corresponding to the first conducting part and the second conducting part, respectively. The first conducting part of the first modular plug is allowed to be inserted into one of the two connecting ports of the modular slot. The second conducting part of the second modular plug is allowed to be inserted into the other one of the two connecting ports of the modular slot.

In an embodiment, the first reading sensor further includes a first engaging part, and the first engaging part is disposed on the first main body. When the first modular plug is inserted into the modular slot of the point-of-service display, the first engaging part and the modular slot of the point-of-service display are engaged with each other, so that the first reading sensor and the point-of-service display are in an engaged state. Alternatively, the second reading sensor further includes a second engaging part, and the second engaging part is disposed on the second main body. When the second modular plug is inserted into the modular slot of the point-of-service display, the second engaging part and the modular slot of the point-of-service display are engaged with each other, so that the second reading sensor and the point-of-service display are in the engaged state.

In an embodiment, the first engaging part includes a first release button. When the first reading sensor and the point-of-service display are in the engaged state, in response to a pressing force by a user on the first release button, the engaged state of the first reading sensor and the point-of-service display is released. Alternatively, the second engaging part includes a second release button. When the second reading sensor and the point-of-service display are in the engaged state, in response to the pressing force by the user on the second release button, the engaged state of the second reading sensor and the point-of-service display is released.

In an embodiment, each of the first modular plug and the second modular plug includes at least one positioning pin, and the modular slot includes at least one positioning hole corresponding to the at least one positioning pin. When each of the first modular plug and the second modular plug is inserted into the modular slot of the point-of-service display, the positioning pin is inserted into the positioning hole.

In an embodiment, the point-of-service display further includes a covering plate for pivotally covering the modular slot.

In an embodiment, the point-of-service display further includes a pivotal shaft. The covering plate is pivotally coupled to the point-of-service display via the pivotal shaft.

In an embodiment, each of the first reading sensor and the second reading sensor is selected from at least one of a magnetic stripe reader (MSR), a fingerprint reader, an iButton reader and a composite reader.

In accordance with another aspect of the present invention, there is provided a point-of-service device. The point-of-service device includes a point-of-service display and a reading sensor. The point-of-service display includes a display body and a modular slot. The modular slot is formed in a rim frame of the display body. The reading sensor may be inserted into the modular slot of the point-of-service display. The reading sensor includes a main body and a modular plug. The main body includes a reading unit. The modular plug is fixed on the main body and electrically connected with the reading unit. The modular plug matches the modular slot of the point-of-service display.

In an embodiment, the reading sensor includes an engaging part, and the engaging part is disposed on the main body. When the modular plug is inserted into the modular slot of the point-of-service display, the engaging part and the modular slot of the point-of-service display are engaged with each other, so that the reading sensor and the point-of-service display are in an engaged state.

In an embodiment, the engaging part includes a release button. When the reading sensor and the point-of-service display are in the engaged state, in response to a pressing force by the user on the release button, the engaged state of the reading sensor and the point-of-service display is released.

In an embodiment, the modular plug includes at least one positioning pin, and the modular slot includes at least one positioning hole corresponding to the at least one positioning pin. When the modular plug is inserted into the modular slot of the point-of-service display, the positioning pin is inserted into the positioning hole.

In an embodiment, the point-of-service display further includes a covering plate for pivotally covering the modular slot.

In accordance with a further aspect of the present invention, there is provided a reading sensor to be inserted into a modular slot of a point-of-service display. The reading sensor includes a main body, a modular plug, and an engaging part. The main body includes a reading unit. The modular plug is fixed on the main body and electrically connected with the reading unit. The modular plug is allowed to be accommodated within the modular slot of the point-of-service display. The engaging part is disposed on the main body. When the modular plug is inserted into the modular slot of the point-of-service display, the engaging part is engaged with the modular slot of the point-of-service display, so that the reading sensor and the point-of-service display are in an engaged state.

In an embodiment, the engaging part includes a release button. When the reading sensor and the point-of-service display are in the engaged state, in response to a pressing force by the user on the release button, the engaged state of the reading sensor and the point-of-service display is released.

In an embodiment, the modular plug includes at least one positioning pin, and the modular slot includes at least one positioning hole corresponding to the at least one positioning pin. When the modular plug is inserted into the modular slot of the point-of-service display, the positioning pin is inserted into the positioning hole.

In an embodiment, the point-of-service display further includes a covering plate for pivotally covering the modular slot.

In an embodiment, the point-of-service display further includes a pivotal shaft. The covering plate is pivotally coupled to the point-of-service display via the pivotal shaft.

In an embodiment, the covering plate is made of a rubbery material.

In an embodiment, the engaging part and the modular plug are parallel with each other, and the engaging part and the modular plug are separated from each other by a gap.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the combination of a point-of-service display and a reading sensor of a point-of-service device according to a first embodiment of the present invention;

FIG. 2 is a schematic perspective view illustrating the point-of-service device according to the first embodiment of the present invention, in which the point-of-service display and two different reading sensors are detached from each other;

FIG. 3 is a schematic partial side view illustrating the modular slot of the point-of-service display of the point-of-service device according to the first embodiment of the present invention, in which the modular slot is partially sheltered by a covering plate;

FIG. 4 is a schematic partial side view illustrating the modular slot of the point-of-service display of the point-of-service device according to the first embodiment of the present invention, in which the modular slot is not sheltered by the covering plate;

FIG. 5 is a schematic perspective view illustrating the two different reading sensors of the point-of-service device according to the first embodiment of the present invention;

FIG. 6 is a schematic perspective view illustrating the two different reading sensors of FIG. 5 and taken along another viewpoint;

FIG. 7 is a schematic perspective view illustrating a point-of-service device according to a second embodiment of the present invention, in which a point-of-service display and two different reading sensors are detached from each other;

FIG. 8 is a schematic perspective view illustrating a point-of-service display of a point-of-service device according to a third embodiment of the present invention; and

FIG. 9 is a schematic perspective view illustrating the combination of the point-of-service display and three reading sensors of the point-of-service device according to the third embodiment of the present invention.

### DETAILED DESCRIPTION OF THE PREFERRED EMBODIMENT

The present invention provides a point-of-service device. The point-of-service device may be installed in a chain convenient store with widespread sales channels. Moreover, the point-of-service device is capable of quickly confirming the electronic information content stored in an electronic card of a user, or confirming the information content stored in an iButton, or identifying any physical object or any picture (e.g. the user's fingerprint or barcodes).

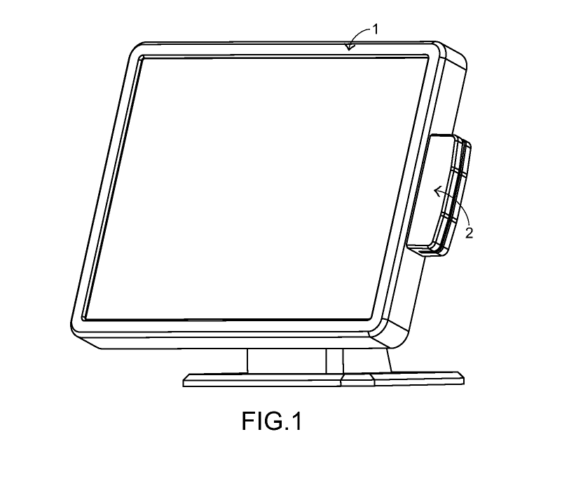

FIG. 1 is a schematic perspective view illustrating the combination of a point-of-service display and a reading sensor of a point-of-service device according to a first embodiment of the present invention. As shown in FIG. 1, the point-of-service device comprises a point-of-service display 1 and a reading sensor 2. In accordance with the design of the present invention, the point-of-service display 1 and the reading sensor 2 may be selectively combined together or detached from each other according to the user's requirements.

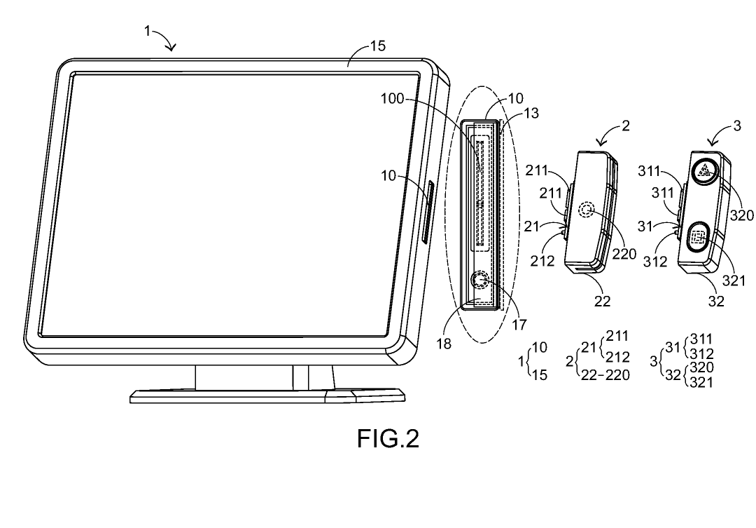

FIG. 2 is a schematic perspective view illustrating the point-of-service device according to the first embodiment of the present invention, in which the point-of-service display and two different reading sensors are detached from each other. For enhancing the functions and applications of the point-of-service device, it is preferred that various types of reading sensors can be applied to the point-of-service device of the present invention. For example, as shown in FIG. 2, a first reading sensor 2 and a second reading sensor 3 may be applied to the point-of-service device. As previously described, since the conventional reading sensors for providing different functions have different types of plugs, the display screen of the conventional point-of-service device should be equipped with a plurality of insertion holes for complying with different types of plugs. For solving these drawbacks, the point-of-service display 1 of the point-of-service device of the present invention has a modular slot 10, and the reading sensors 2 and 3 have respective plugs 21 and 31 matching the modular slot 10. In other words, both of the plugs 21 and 31 of the reading sensors 2 and 3 for providing different functions can be accommodated within the modular slot 10. Consequently, even if the point-of-service display 1 has a single modular slot 10, either the first reading sensor 2 or the second reading sensor 3 may be selectively combined with the point-of-service display 1 through the modular slot 10.

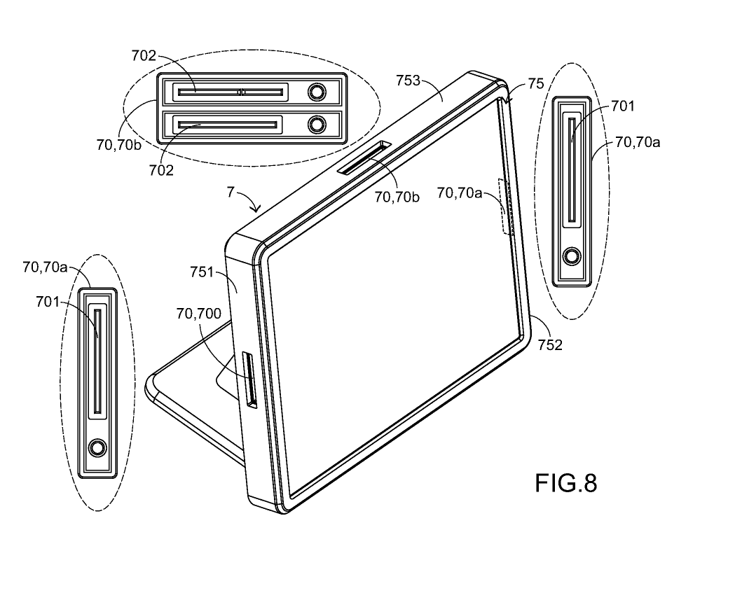

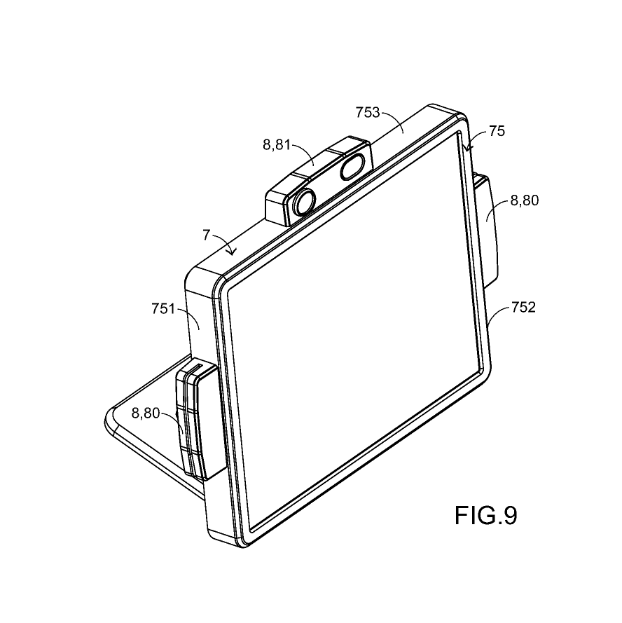

In this embodiment, the point-of-service display 1 comprises a display body 15. Preferably, the modular slot 10 is formed in a rim frame of the display body 15. The detailed structure of the rim frame will be illustrated later with reference to FIGS. 8 and 9. The position of the modular slot 10 is presented herein for purpose of illustration and description only. It is noted that the modular slot 10 may be located at another position of the point-of-service display 1. For example, the modular slot 10 may be located at a backside cover or a base of the point-of-service display 1, but is not limited thereto.

Please refer to FIG. 2 again. The first reading sensor 2 comprises a first modular plug 21 and a first main body 22. The first main body 22 comprises a first reading unit 220. In addition, the first reading unit 220 is electrically connected with the first modular plug 21. In this embodiment, the first reading unit 220 is a magnetic stripe reading unit, and the first reading sensor 2 is a magnetic stripe reader (MSR).

The second reading sensor 3 comprises a second modular plug 31 and a second main body 32. According to the practical requirements of the user, the second reading sensor 3 may be selected from a fingerprint reader, an iButton reader or a composite reader. In this embodiment, the second reading sensor 3 is the composite reader. In addition, the second main body 32 comprises two second reading units 320 and 321. These two second reading units 320 and 321 are an iButton reading unit and a fingerprint reading unit, respectively.

Please refer to FIG. 2 again. The first modular plug 21 and the second modular plug 31 comprise conducting parts 211 and 311, respectively. The conducting parts 211 and 311 have the same outer appearance. The modular slot 10 has a single connecting port 100 corresponding to the conducting parts 211 and 311. Consequently, the conducting parts 211 and 311 can be inserted into the single connecting port 100. In this embodiment, either the conducting part 211 of the first modular plug 21 or the conducting part 311 of the second modular plug 31 is allowed to be inserted into the single connecting port 100 of the modular slot 10 at the same time.

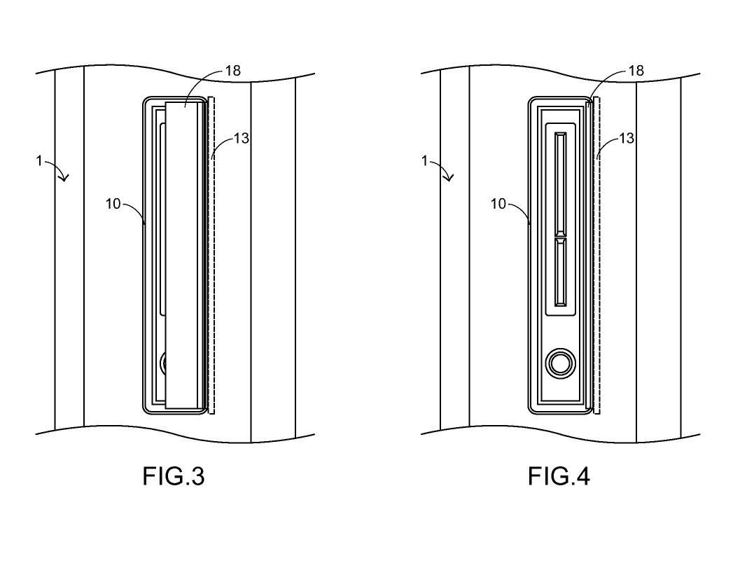

Moreover, the point-of-service display 1 further comprises a covering plate 18. The covering plate 18 is used for pivotally covering the modular slot 10. Hereinafter, the operations of the covering plate 18 will be illustrated with reference to FIGS. 2, 3 and 4. FIG. 3 is a schematic partial side view illustrating the modular slot of the point-of-service display of the point-of-service device according to the first embodiment of the present invention, in which the modular slot is partially sheltered by a covering plate. FIG. 4 is a schematic partial side view illustrating the modular slot of the point-of-service display of the point-of-service device according to the first embodiment of the present invention, in which the modular slot is not sheltered by the covering plate.

In particular, the point-of-service display 1 further comprises a pivotal shaft 13. The covering plate 18 is pivotally coupled to the point-of-service display 1 via the pivotal shaft 13. In a case that the no modular plug is inserted into the modular slot 10, the covering plate 18 may shelter at least a portion of the modular slot 10 in order to prevent dust, moisture or any other contaminant from entering into the modular slot 10. During the first modular plug 21 or the second modular plug 31 is introduced into the modular slot 10, the covering plate 18 may be directly pushed and rotated by the first modular plug 21 or the second modular plug 31. Consequently, the modular slot 10 is exposed (see FIG. 4). Afterwards, the first modular plug 21 or the second modular plug 31 can be inserted into and connected with the modular slot 10.

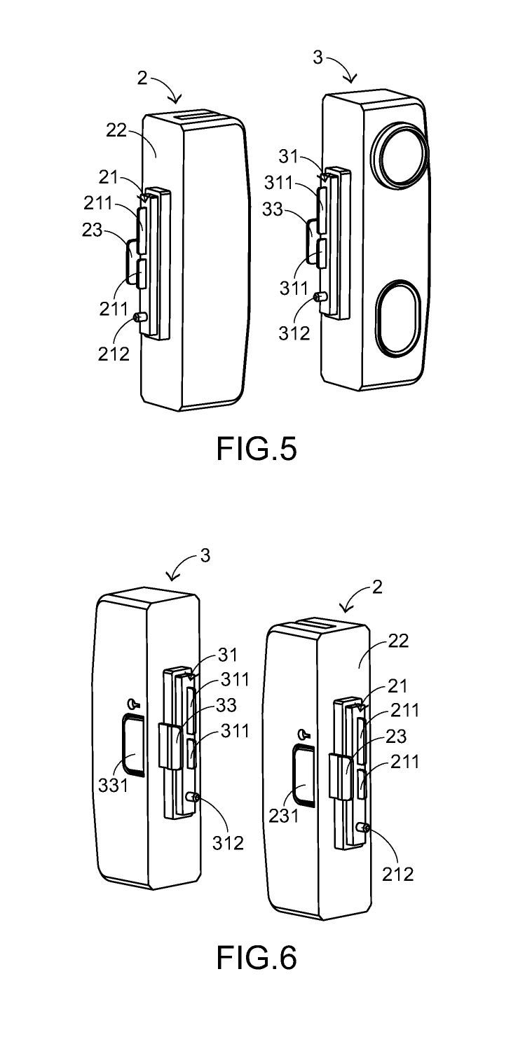

FIG. 5 is a schematic perspective view illustrating the two different reading sensors of the point-of-service device according to the first embodiment of the present invention. FIG. 6 is a schematic perspective view illustrating the two different reading sensors of FIG. 5 and taken along another viewpoint. Please refer to FIGS. 5 and 6 as well as FIG. 2. Moreover, for quickly assembling the point-of-service device in a time-saving manner, the modular slot 10 and the first modular plug 21 or the second modular plug 31 are engaged with each other via an engaging part, instead of screws. The uses of the engaging part will be illustrated later.

Please refer to FIGS. 2-6 again. Take the first reading sensor 2 for example. The first reading sensor 2 further comprises a first engaging part 23. The first engaging part 23 is disposed on the first main body 22. When the first modular plug 21 is inserted into the modular slot 10 of the point-of-service display 1, the first engaging part 23 and an engaging structure (not shown) of the modular slot 10 can be engaged with each other. Consequently, the first reading sensor 2 and the point-of-service display 1 are in an engaged state. It is noted that the engaging structure of the modular slot 10 to be engaged with the first engaging part 23 is not restricted. For example, the engaging structure of the modular slot 10 is an indentation (not shown), and the first engaging part 23 is engaged with the indentation. Moreover, those skilled in the art will readily observe that numerous modifications and alterations of the engaging structure may be made while retaining the teachings of the invention. In this embodiment, the first engaging part 23 and the first modular plug 21 are parallel with each other. In addition, the first engaging part 23 and the first modular plug 21 are separated from each other by a gap. Due to this arrangement, during the first engaging part 23 of the first reading sensor 2 is inserted into the point-of-service display 1, the first engaging part 23 is pushed by the modular slot 10 and subjected to deformation. Under this circumstance, the first engaging part 23 is allowed to be slightly deformed toward the first modular plug 21. Preferably, the second reading sensor 3 also comprises a second engaging part 33. The arrangement of the second engaging part 33 of the second reading sensor 3 is similar to that of the first engaging part 23 of the first reading sensor 2, and is not redundantly described herein.

Moreover, for facilitating the user to remove the first reading sensor 2 from the point-of-service display 1, the first engaging part 23 has a first release button 231. When the first reading sensor 2 and the point-of-service display 1 are in the engaged state, in response to a pressing force by the user on the first release button 231, the engagement between the first reading sensor 2 and the point-of-service display 1 is released. That is, the engaged state can be easily released by a simple pressing action on the releasing button without the need of additionally preparing an assembling/disassembling tool. Consequently, the way of detaching the first reading sensor 2 from the point-of-service display 1 is convenient and time-saving. Preferably, the second reading sensor 3 also comprises a second releasing button 331. The arrangement of the second releasing button 331 of the second reading sensor 3 is similar to that of the first release button 231 of the first reading sensor 2, and is not redundantly described herein.

For allowing the first reading sensor 2 or the second reading sensor 3 to be fixed on the point-of-service display 1 more securely, the first modular plug 21 further comprises at least one positioning pin 212, and the modular slot 10 has at least one positioning hole 17 corresponding to the at least one positioning pin 212. Consequently, when the first modular plug 21 is inserted into the modular slot 10 of the point-of-service display 1, the positioning pin 212 is inserted into the corresponding positioning hole 17. Similarly, the second modular plug 31 further comprises at least one positioning pin 312. Due to the positioning pin 212 or 312, the first reading sensor 2 or the second reading sensor 3 can be engaged with the point-of-service display 1 more securely.

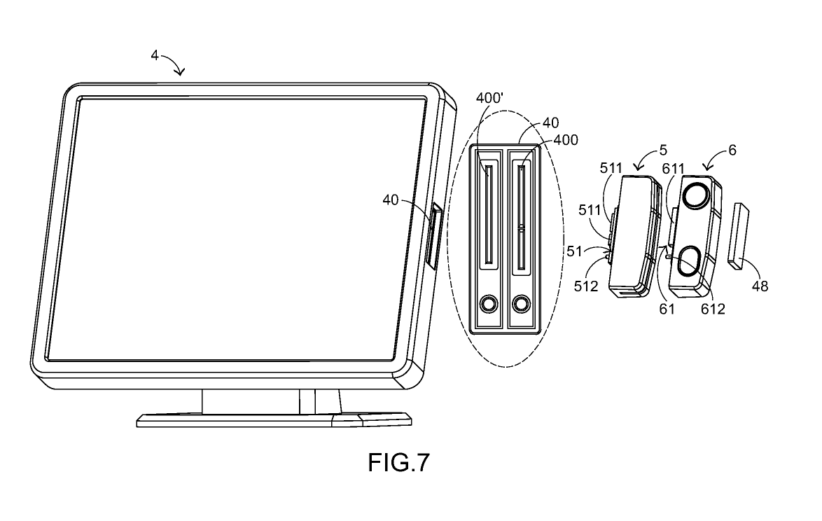

FIG. 7 is a schematic perspective view illustrating a point-of-service device according to a second embodiment of the present invention, in which a point-of-service display and two different reading sensors are detached from each other. As shown in FIG. 7, the point-of-service device comprises a point-of-service display 4 and two different reading sensors 5 and 6. In this embodiment, a first modular plug 51 of the first reading sensor 5 and a second modular plug 61 of the second reading sensor 6 have conducting parts 511 and 611, respectively. In comparison with the first embodiment, the conducting parts 511 and 611 of the point-of-service device of this embodiment have different outer appearances. Moreover, a modular slot 40 of the point-of-service display 4 has two connecting ports 400 and 400′ with different profiles. The conducting part 511 of the first modular plug 51 can be inserted into the connecting port 400 of the modular slot 40. The conducting part 611 of the second modular plug 61 can be inserted into the connecting port 400′ of the modular slot 40. In this embodiment, either the conducting part 511 of the first modular plug 51 or conducting part 611 of the second modular plug 61 is allowed to be inserted into the modular slot 40 at the same time.

Moreover, in comparison with the first embodiment, a covering plate 48 of the point-of-service device of this embodiment is an independent rubbery covering plate. In addition, the size of the covering plate 48 matches the modular slot 40. In a case that the no modular plug is inserted into the modular slot 40, the covering plate 48 may shelter the modular slot 40 in order to prevent dust, moisture or any other contaminant from entering into the modular slot 40. On the other hand, after the rubbery covering plate 48 is detached from the modular slot 40 by the user, the modular slot 40 can be utilized to receive a corresponding modular plug.

The other components (e.g. the engaging parts (not shown), the positioning pins 512, 612 and the types of the reading units) of the point-of-service device of this embodiment are similar to those of the first embodiment, and are not redundantly described herein.

FIG. 8 is a schematic perspective view illustrating a point-of-service display of a point-of-service device according to a third embodiment of the present invention. As shown in FIG. 8, the point-of-service display 7 comprises three modular slots 70. These three modular slots 70 are discretely formed in a rim frame 75 of the point-of-service display 7. Preferably, these three modular slots 70 are located at a left side 751, a right side 752 and a top side 753 of the rim frame 75, respectively. It is noted that the number and positions of the modular slots 70 may be varied according to the practical requirements.

Especially, each of the modular slots 70 may be selected from a first type modular slot 70a with a single connecting port 701 or a second type modular slot 70b with two connecting ports 702. In this embodiment, each of the modular slots 70 at the left side 751 and the right side 752 of the rim frame 75 is the first type modular slot 70a with the single connecting port 701, and the modular slot 70 at the top side 753 of the rim frame 75 is the second type modular slot 70b with the two connecting ports 702. The arrangements and types of these modular slots 70 are presented herein for purpose of illustration and description only. It is noted that the arrangements and types of these modular slots 70 may be varied according to the practical requirements. The detailed structures of the first type modular slot 70a with the single connecting port 701 and the second type modular slot 70b with the two connecting ports 702 have been illustrated in the first embodiment, and are not redundantly described herein.

Next, please refer to FIGS. 8 and 9. FIG. 9 is a schematic perspective view illustrating the combination of the point-of-service display and three reading sensors of the point-of-service device according to the third embodiment of the present invention. As shown in FIG. 9, three reading sensors 8 have been respectively inserted into the three modular slots 70 at the left side 751, the right side 752 and the top side 753 of the rim frame 75 of the point-of-service display 7. Similarly, each of the three reading sensors 8 is selected from at least one of a magnetic stripe reader (MSR), a fingerprint reader, an iButton reader and a composite reader. In this embodiment, the two reading sensors 80 inserted into the modular slots 70 at the left side 751 and the right side 752 of the rim frame 75 are magnetic stripe readers, and the reading sensor 81 inserted into the modular slot 70 at the top side 753 of the rim frame 75 is the composite reader. Of course, according to the practical requirements, the reading sensors 8 may be easily detached from the corresponding modular slots 70 and replaced with other types of reading sensors. In comparison with the conventional point-of-service device, the utilization flexibility of the point-of-service device of the present invention is largely enhanced.

From the above descriptions, the present invention provides a point-of-service device. The reading sensors for providing different functions are equipped with respective modular plugs. Correspondingly, only a single modular slot is formed in a point-of-service display of the point-of-service device. The modular plugs of the reading sensors for providing different functions may be inserted into the modular slot. Consequently, the functions of the point-of-service device can be expanded according to the practical requirements of the user. Moreover, the reading sensor used in the point-of-service device of the present invention has an engaging part. When the reading sensor is inserted into the modular slot of the point-of-service display, the engaging part of the reading sensor and the modular slot of the point-of-service display are engaged with each other. Consequently, the process of assembling the point-of-service device is quick and convenient without the need of additionally preparing an assembling/disassembling tool. In other words, the assembling process is more time-saving.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A point-of-service device, comprising:
a point-of-service display comprising a modular slot;
a first reading sensor to be inserted into said modular slot of said point-of-service display, wherein said first reading sensor comprises:
a first main body comprising a first reading unit; and
a first modular plug fixed on said first main body and electrically connected with said first reading unit, wherein said first modular plug matches said modular slot; and
a second reading sensor to be inserted into said modular slot of said point-of-service display, wherein said second reading sensor comprises:
a second main body comprising a second reading unit; and
a second modular plug fixed on said second main body and electrically connected with said second reading unit, wherein said second modular plug matches said modular slot,
wherein either said first modular plug or said second modular plug is allowed to be inserted into said modular slot at the same time.

2. The point-of-service device according to claim 1, wherein said first modular plug comprises a first conducting part, and said second modular plug comprises a second conducting part, wherein said first conducting part and said second conducting part have the same outer appearance, and said modular slot comprises a single connecting port corresponding to said first conducting part or said second conducting part, wherein either said first conducting part or said second conducting part is allowed to be inserted into said single connecting port.

3. The point-of-service device according to claim 1, wherein said first modular plug comprises a first conducting part, and said second modular plug comprises a second conducting part, wherein said first conducting part and said second conducting part have different outer appearances, and said modular slot comprises two different connecting ports corresponding to said first conducting part and said second conducting part, respectively, wherein said first conducting part of said first modular plug is allowed to be inserted into one of said two connecting ports of said modular slot, and said second conducting part of said second modular plug is allowed to be inserted into the other one of said two connecting ports of said modular slot.

4. The point-of-service device according to claim 2,
wherein said first reading sensor further comprises a first engaging part, and said first engaging part is disposed on said first main body, wherein when said first modular plug is inserted into said modular slot of said point-of-service display, said first engaging part and said modular slot of said point-of-service display are engaged with each other, so that said first reading sensor and said point-of-service display are in an engaged state; and/or
wherein said second reading sensor further comprises a second engaging part, and said second engaging part is disposed on said second main body, wherein when said second modular plug is inserted into said modular slot of said point-of-service display, said second engaging part and said modular slot of said point-of-service display are engaged with each other, so that said second reading sensor and said point-of-service display are in said engaged state.

5. The point-of-service device according to claim 4,
wherein said first engaging part comprises a first release button, wherein when said first reading sensor and said point-of-service display are in said engaged state, in response to a pressing force by a user on said first release button, said engaged state of said first reading sensor and said point-of-service display is released; and/or
wherein said second engaging part comprises a second release button, wherein when said second reading sensor and said point-of-service display are in said engaged state, in response to said pressing force by said user on said second release button, said engaged state of said second reading sensor and said point-of-service display is released.

6. The point-of-service device according to claim 1, wherein each of said first modular plug and said second modular plug comprises at least one positioning pin, and said modular slot comprises at least one positioning hole corresponding to said at least one positioning pin, wherein when each of said first modular plug and said second modular plug is inserted into said modular slot of said point-of-service display, said positioning pin is inserted into said positioning hole.

7. The point-of-service device according to claim 1, wherein said point-of-service display further comprises a covering plate for pivotally covering said modular slot.

8. The point-of-service device according to claim 7, wherein said point-of-service display further comprises a pivotal shaft, wherein said covering plate is pivotally coupled to said point-of-service display via said pivotal shaft.

9. The point-of-service device according to claim 1, wherein each of said first reading sensor and said second reading sensor is selected from at least one of a magnetic stripe reader (MSR), a fingerprint reader, an iButton reader and a composite reader.

10. A point-of-service device, comprising:
a point-of-service display comprising a display body and a modular slot, wherein said modular slot is formed in a rim frame of said display body; and
a reading sensor to be inserted into said modular slot of said point-of-service display, wherein said reading sensor comprises:
a main body comprising a reading unit; and
a modular plug fixed on said main body and electrically connected with said reading unit, wherein said modular plug matches said modular slot of said point-of-service display.

11. The point-of-service device according to claim 10, wherein said reading sensor comprises an engaging part, and said engaging part is disposed on said main body, wherein when said modular plug is inserted into said modular slot of said point-of-service display, said engaging part and said modular slot of said point-of-service display are engaged with each other, so that said reading sensor and said point-of-service display are in an engaged state.

12. The point-of-service device according to claim 11, wherein said engaging part comprises a release button, wherein when said reading sensor and said point-of-service display are in said engaged state, in response to a pressing force by said user on said release button, said engaged state of said reading sensor and said point-of-service display is released.

13. The point-of-service device according to claim 10, wherein said modular plug comprises at least one positioning pin, and said modular slot comprises at least one positioning hole corresponding to said at least one positioning pin, wherein when said modular plug is inserted into said modular slot of said point-of-service display, said positioning pin is inserted into said positioning hole.

14. The point-of-service device according to claim 10, wherein said point-of-service display further comprises a covering plate for pivotally covering said modular slot.

15. A reading sensor to be inserted into a modular slot of a point-of-service display, said reading sensor comprising:
a main body comprising a reading unit;
a modular plug fixed on said main body and electrically connected with said reading unit, wherein said modular plug is allowed to be accommodated within said modular slot of said point-of-service display; and
an engaging part disposed on said main body,
wherein when said modular plug is inserted into said modular slot of said point-of-service display, said engaging part is engaged with said modular slot of said point-of-service display, so that said reading sensor and said point-of-service display are in an engaged state.

16. The reading sensor according to claim 15, wherein said engaging part comprises a release button, wherein when said reading sensor and said point-of-service display are in said engaged state, in response to a pressing force by said user on said release button, said engaged state of said reading sensor and said point-of-service display is released.

17. The reading sensor according to claim 15, wherein said modular plug comprises at least one positioning pin, and said modular slot comprises at least one positioning hole corresponding to said at least one positioning pin, wherein when said modular plug is inserted into said modular slot of said point-of-service display, said positioning pin is inserted into said positioning hole.

18. The reading sensor according to claim 15, wherein said point-of-service display further comprises a covering plate for pivotally covering said modular slot.

19. The reading sensor according to claim 18, wherein said point-of-service display further comprises a pivotal shaft, wherein said covering plate is pivotally coupled to said point-of-service display via said pivotal shaft.

20. The reading sensor according to claim 18, wherein said covering plate is made of a rubbery material.

21. The reading sensor according to claim 15, wherein said engaging part and said modular plug are parallel with each other, and said engaging part and said modular plug are separated from each other by a gap.

22. The point-of-service device according to claim 3,
wherein said first reading sensor further comprises a first engaging part, and said first engaging part is disposed on said first main body, wherein when said first modular plug is inserted into said modular slot of said point-of-service display, said first engaging part and said modular slot of said point-of-service display are engaged with each other, so that said first reading sensor and said point-of-service display are in an engaged state; and/or
wherein said second reading sensor further comprises a second engaging part, and said second engaging part is disposed on said second main body, wherein when said second modular plug is inserted into said modular slot of said point-of-service display, said second engaging part and said modular slot of said point-of-service display are engaged with each other, so that said second reading sensor and said point-of-service display are in said engaged state.

23. The point-of-service device according to claim 22,
wherein said first engaging part comprises a first release button, wherein when said first reading sensor and said point-of-service display are in said engaged state, in response to a pressing force by a user on said first release button, said engaged state of said first reading sensor and said point-of-service display is released; and/or
wherein said second engaging part comprises a second release button, wherein when said second reading sensor and said point-of-service display are in said engaged state, in response to said pressing force by said user on said second release button, said engaged state of said second reading sensor and said point-of-service display is released.
